(19) United States
(12) Patent Application Publication
(10) Pub. No.: US 2017/0221131 A1
(43) Pub. Date: Aug. 3, 2017

(54) Method for Encoding Orders and Expediting Order Processing Across a Distributed Network

(71) Applicant: Samara Lynn Sullivan, Fort McMurray (CA)

(72) Inventor: Samara Lynn Sullivan, Fort McMurray (CA)

(21) Appl. No.: 15/009,394

(22) Filed: Jan. 28, 2016

(51) Int. Cl. G06Q 30/06; G06Q 20/20

(52) U.S. Cl. CPC G06Q 30/0635; G06Q 20/202

(57) ABSTRACT

A method for encoding orders and expediting order processing across a distributed network that enables expedited processing of orders, and expedient fulfillment of repeatable orders, by use of a code in lieu of particular order data, wherein a code input into a merchant point of sale effects communication with a remote server hosting a unique customer account whereby particular order data, associated by the customer with the specific code, is retrievable to effect expeditious fulfillment of the order by use of the code as proxy.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Various types of methods for processing orders and expediting order processing are known in the prior art. However, what is needed is a method for encoding orders and expediting order processing across a ddistributed network that enables expedited processing of orders, and expedient fulfillment of repeatable orders, by use of a code in lieu of particular order data, wherein a code input into a merchant point of sale effects communication with a remote server hosting a unique customer account whereby particular order data, associated by the customer with the specific code, is retrievable to effect expeditious fulfillment of the order by use of the code as proxy.

### FIELD OF THE INVENTION

The present invention relates to a method for encoding orders and expediting order processing across a distributed network, and more particularly, to a method for encoding orders and expediting order processing across a distributed network that enables expedited processing of orders, and expedient fulfillment of repeatable orders, by use of a code in lieu of particular order data, wherein a code input into a merchant point of sale effects communication with a remote server hosting a unique customer account whereby particular order data, associated by the customer with the specific code, is retrievable to effect expeditious fulfillment of the order by use of the code as proxy.

### SUMMARY OF THE INVENTION

The general purpose of the method for encoding orders and expediting order processing across a distributed network, described subsequently in greater detail, is to provide a method for encoding orders and expediting order processing across a distributed network which has many novel features that result in a method for encoding orders and expediting order processing across a distributed network which is not anticipated, rendered obvious, suggested, or even implied by prior art, either alone or in combination thereof.

The term “point of sale”, as used herein throughout, is taken to include any means to capture a sale of a particular good or service whether manipulated by a sales representative, a merchant, or a customer directly, and includes, for example, a webpage, a graphical user interface (“GUI”), a receipting till, or any other means usable in the present day to capture a sale disposed in networked communication with a server hosting a unique customer account.

The term “particular order data”, as used herein throughout, is taken to mean all data pertinent to fulfilling an order. For food orders, for example particular order data includes ingredients, cooking options (rare, medium, etc.), and other data input to control provision of a food order (such as exclusion of some ingredients or special ordering instructions). For other orders for goods, particular order data includes relevant data required to fulfill a purchase, such as, for example sizes, accouterments, weights and measures, options, colors, materials, and any other such data input to enable purchasing said good. Particular order data may likewise include service data, such as delivery, pick up, and other services and options offered by service providers.

The term “merchant”, as used herein throughout, is taken to include any party selling a good or service, or offering any such good or service for sale. The term “customer”, as used herein throughout, is taken to include any party procuring, or seeking to procure, goods or services whereby use of a code in lieu of repeated order instructions may expedite order processing.

The present method for encoding orders and expediting order processing across a distributed network, therefore, has been devised to enable expedited fulfillment of orders by a merchant whereby a customer may effect an order in less time by utterance or input of a single code as proxy for particular order data. The present method for encoding orders and expediting order processing across a distributed network, therefore, uses a code, generable at a unique customer account accessible via Internet protocol between communicating computing devices, to encode complex and repeatable orders with a single code word or phrase. The code may be alphanumeric, a word, or any such abbreviation usable as proxy for particular order data.

The present method for encoding orders and expediting order processing across a distributed network, therefore, includes a unique customer account accessible via Internet protocol. A customer is enabled access to said unique customer account, whereby a code is generable as metadata for particular order data assignable by the customer for association with said code. Thus, use of the code when placing an order at any merchant point of sale enables communication of the code through the merchant order processing system and fulfillment of the particular order data.

Thus, a customer who frequently orders food from a particular store, for example, may generate a code for a familiar order such as, for example, an order that serves more than one person a variety of sandwiches say, with special ingredients, drinks, special order instructions, for delivery to a particular address. This code could be 000123, for example, or “party mix”, say. Entering the code into the point of sale, or having a sales representative at the merchant side enter the code into a point of sale, will effect fulfillment of the particular order data whereby delivery of the sandwiches, drinks, with attention to special ordering instructions (such as food allergies and the like), is effective to the particular address by simple utterance, or entry, of the single code word or phrase.

The present method is applicable not just for food orders, but for any orders for any good or service wherein a code is usable as proxy metadata for particular order data. Thus repeatable orders frequently placed with consistent details are expeditiously processed with reference to the stated code, as desired.

Customers are enabled to update codes storable in association with the unique customer account. A customer may generate new codes and edit previous codes. At time of sale, the point of sale communicates with a server via Internet protocol to retrieve the particular order data for which the code is entered as proxy. The particular order data is then sent down the order processing system and the order is fulfilled. Thus particular order data is updateable, as desired, and usable at time of sale to fulfill an order placed.

Thus has been broadly outlined the more important features of the present method for encoding orders and expediting order processing across a distributed network so that the detailed description thereof that follows may be better understood and in order that the present contribution to the art may be better appreciated.

Objects of the present method for encoding orders and expediting order processing across a distributed network, along with various novel features that characterize the invention are particularly pointed out in the claims forming a part of this disclosure. For better understanding of the method for encoding orders and expediting order processing across a distributed network, its operating advantages and specific objects attained by its uses, refer to the accompanying drawings and description.

### BRIEF DESCRIPTION OF THE DRAWINGS

### Figures

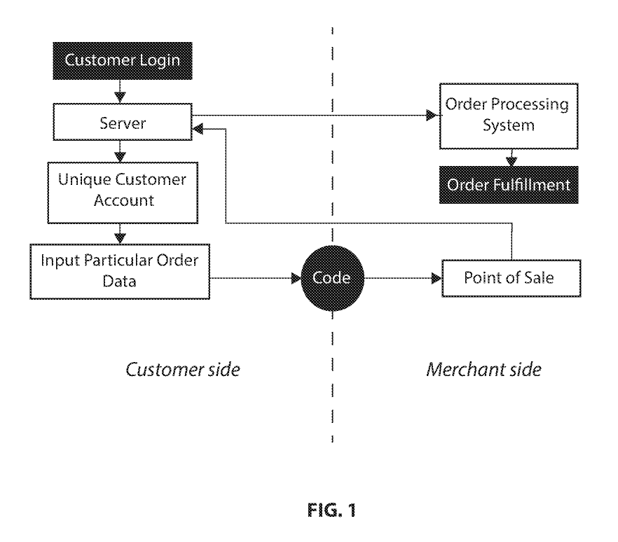

FIG. 1 is a block diagram view of an example embodiment.

### DETAILED DESCRIPTION OF THE DRAWINGS

With reference now to the drawings, and in particular FIG. 1 thereof, example of the instant method for encoding orders and expediting order processing across a distributed network employing the principles and concepts of the present method for encoding orders and expediting order processing across a distributed network and generally designated by the reference number will be described.

Referring to FIG. 1 an example embodiment of the present method for encoding orders and expediting order processing across a distributed network is illustrated.

The present method for encoding orders and expediting order processing across a distributed network has been devised to enable simplification of orders and expedition of processing of said orders by establishing a code for input into any merchant point of sale whereby particular order data, associated with said code by a customer having a unique customer account, is generable into an order processing system by action of inputting the code in lieu of the particular order data.

Thus the present code is metadata for actual order data and serves as proxy. Repeated orders are more readily effected by input of the code, at any point of sale, whereby actual order data is routable through an order processing system using the code as proxy. The present method includes multiple embodiments across multiple platforms, and is usable with food orders, item orders for sale, or any order likely to be repeated often enough wherein use of a code to expedite order fulfillment and save time when inputting the order at the point of sale is desirable.

The present method, therefore, includes the steps of assigning a code for download to a unique customer account. The code is selectable, or generable, at setup of a customer account in connection with a particular merchant. A customer may, therefore, select or generated a code as proxy for particular order data which is subsequently associated with the selected code. An example might be “Mealfor4”, which includes particular orders—and any ingredients or custom order instructions—for four people with options, such as delivery or pickup for example, defined therein.

Once a code has been assigned, the customer is able to input the code in lieu of the particular order data at time of purchase, the code standing as a proxy for said particular order data, whereby input of the code generates expedited fulfillment of the order on the merchant order processing side.

A customer thus selects a code, or creates a unique code, and designates the code to particular order data to enable processing of any good or service offered by a merchant able to process the code in connection with said order data. The code and associated particular order data may be stored in a database connected with a server, whereby entry of the code at point of sale initiates communication with said server to access the customer account in the database and thus retrieve the particular order data associated with said code.

When the code is entered into a merchant order processing system, the particular order data is retrieved and fulfillment of the customer order is enabled. The particular order data associated with the code is processed along the order processing system, and the customer need only provide the code at point of sale. Thus time is saved effecting any order, at any point of sale, in person, over the telephone, or via networked computing or peripheral devices, as case may be.

The present method for encoding orders and expediting order processing across a distributed network may also include a server, connected in network with the merchant order processing system. The server is accessible by customers over Internet protocol to enable customer side management of codes assigned to unique customer accounts. Communication between the server and the merchant order processing system is effective to update said merchant processing system with updated codes, as administered by the customer.

Any merchant point of sale is caused to communicate with the server when a code is entered therein, whereby the point of sale initiates retrieval of the particular order data for which the code is used as proxy. The code is thus customer controllable and updateable to reflect new order data, when desired, whereby updateable order data is distributable to the merchant order processing system when the code is entered at any merchant point of sale.

What is claimed is:

1. A method for encoding orders and expediting order processing across a distributed network, said method comprising the steps of:
assigning a code for download to a unique customer account, said code storable and alternatively generable for selection and input at a merchant account;
enabling customer input to designate the code to particular order data enabling processing of any good or service offered by the merchant in connection with said order data;
storing the particular order data in connection with the code; and
retrieving said particular order data when the code is entered into a merchant point of sale to enable fulfillment of the customer order, said customer providing only the code at any point of sale;
wherein said code is usable by a customer to effect ordering of particular goods and services, whereby input of the code into a merchant point of sale automates communication of the particular order data through a merchant order processing system to expedite processing of the order.

2. A method for encoding orders and expediting order processing across a distributed network of claim 1 further comprising the steps of:
connecting a server in network with the merchant order processing system, said server accessible by customers over Internet protocol;
enabling customer side management of codes assigned to unique customer accounts;
effecting communication between the server and the merchant order processing system to update said merchant processing system; and
effecting communication from any merchant point of sale with the server when a code is entered therein;
wherein the code is customer controllable and updateable to reflect new order data when desired, whereby updateable order data is distributed to the merchant order processing system when the code is entered at any merchant point of sale.

3. The method for encoding orders and expediting order processing across a distributed network of claim 2 wherein the merchant point of sale includes a webpage, a form field, a point of sale terminal, or any networked interface wherein a code is enterable by the customer or an employee manipulating said point of sale.
